(19) United States
(12) Patent Application Publication
(10) Pub. No.: US 2017/0171259 A1
(43) Pub. Date: Jun. 15, 2017

(54) INFORMATION PROVIDING APPARATUS, RECORDING MEDIUM, AND INFORMATION PROVIDING METHOD

(71) Applicants: Yuya TAKAO, Kanagawa (JP); Kazuhisa ARIGAYA, Tokyo (JP)

(72) Inventors: Yuya TAKAO, Kanagawa (JP); Kazuhisa ARIGAYA, Tokyo (JP)

(73) Assignee: Ricoh Company, Ltd., Tokyo (JP)

(21) Appl. No.: 15/116,890

(22) PCT Filed: Jan. 20, 2015
(86) PCT No.: PCT/JP2015/051951

§ 371 Date: Aug. 5, 2016

(30) Foreign Application Priority Data
Feb. 24, 2014 (JP) 2014-032498

(51) Int. Cl. H04L 29/06

(52) U.S. Cl. CPC H04L 65/403; H04L 65/1073

(57) ABSTRACT

An information providing apparatus that provides a terminal device with information includes an address analysis unit that analyzes one of a plurality of addresses assigned to the information providing apparatus when the one of the plurality of addresses is accessed by the terminal device, and an information providing unit that acquires a group associated with the address analyzed by the address analysis unit based on group information in which a plurality of groups are associated with the plurality of addresses, and provides the terminal device with information associated with the acquired group.

### TECHNICAL FIELD

The present invention relates to an information providing apparatus, a recording medium, and an information providing method.

### BACKGROUND ART

Conventionally, a screen sharing service providing system in which a shared display content between information processing apparatuses is stored beforehand is known. In this screen sharing service providing system, only operation information indicating an input operation accepted by an information processing apparatus as a transmission source node is transmitted via a network to another information processing apparatus as a destination node so that a display screen on which the input operation is reflected may be shared between the source and destination nodes with a reduced amount of transmission data. For example, see Japanese Laid-Open Patent Publication No. 2012-108872.

### SUMMARY OF THE INVENTION

### Problems to be Solved by the Invention

In the screen sharing service providing system according to the related art, there is a demand for providing separate shared screens for several groups, such as several divisions of a company or several faculties of a university, from the viewpoint of security. However, in the screen sharing service providing system according to the related art, when it is desired to provide separate shared screens for several groups, a corresponding number of server devices each adapted to provide a screen sharing service must be installed in the system for the groups, and the server device to be accessed must be selected from among the server devices according to the group concerned. Moreover, when separate shared screens are provided for several groups, the screen sharing service providing system according to the related art must manage each group with a corresponding user's account.

The above problem also arises in an information providing apparatus according to the related art adapted to provide information for several terminal devices as well as in the screen sharing service providing system.

Accordingly, in view of the above-described problem, the present invention aims at providing an information providing apparatus, a recording medium, and an information providing method which are adapted to easily perform a process which provides separate information items for several groups.

### Means for Solving the Problems

In one aspect, the present invention provides an information providing apparatus which easily performs a process which provides separate information items for several groups.

In one embodiment, the present invention provides an information providing apparatus that provides a terminal device with information, the information providing apparatus including: a processing circuitry, and a memory storing computer readable code that, when executed by the processing circuitry, causes the processing circuitry to act as an address analysis unit configured to analyze one of a plurality of addresses assigned to the information providing apparatus when the one of the plurality of addresses is accessed by the terminal device, and an information providing unit configured to acquire a group associated with the address analyzed by the address analysis unit based on group information in which a plurality of groups are associated with the plurality of addresses, and provide the terminal device with information associated with the acquired group.

The information providing apparatus according to one embodiment of the present invention is capable of easily performing the process which provides separate information items for several groups.

Other objects, features and advantages of embodiments will be apparent from the following detailed description when read in conjunction with the accompanying drawings.

### BRIEF DESCRIPTION OF THE DRAWINGS

FIG. 1 is a block diagram showing a system configuration of a teleconference system according to an embodiment.

FIG. 2 is a diagram showing a hardware configuration of a computer according to an embodiment.

FIG. 3 is a block diagram showing a functional configuration of a registration terminal.

FIG. 4 is a block diagram showing a functional configuration of a conference server device.

FIG. 5 is a block diagram showing a functional configuration of an attendance terminal.

FIG. 6 is a diagram for explaining an example of a group registration process.

FIG. 7 is a diagram for explaining an example of a conference registration process.

FIG. 8 is a diagram for explaining an example of a process which acquires conference information for which grouping is carried out.

FIG. 9 is a diagram for explaining an example of a conference list acquisition process.

FIG. 10 is a diagram showing an example of a conference list screen.

FIG. 11 is a diagram showing another example of the conference list screen.

### MODE FOR CARRYING OUT THE INVENTION

A description will be given of an embodiment with reference to the accompanying drawings. In this embodiment, a teleconference system 1 is explained as an example of an information providing system. In the teleconference system 1, an attendance terminal acquires different conference lists for a plurality of groups from a conference server device and displays a conference list on a display screen of the attendance terminal. The conference server device is an example of an information providing apparatus. The conference list is an example of different information items provided, for several groups by the information providing apparatus.

### First Embodiment

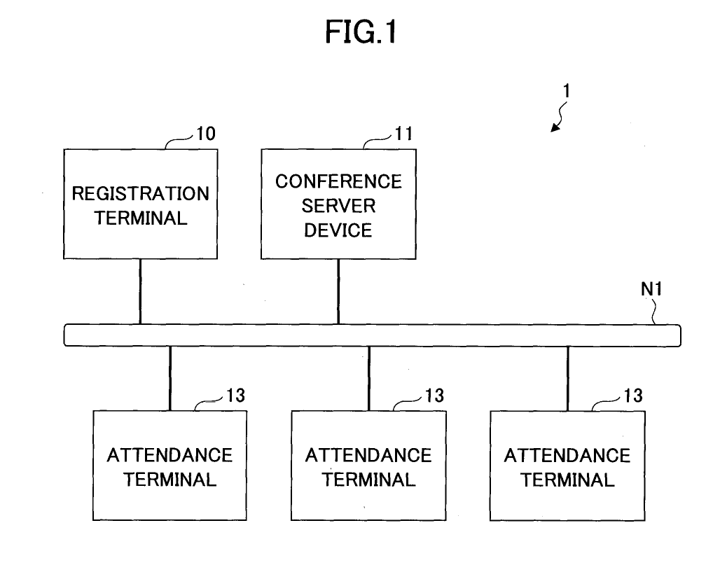

FIG. 1 is a block diagram showing a configuration of a teleconference system 1 according to this embodiment. As shown in FIG. 1, the teleconference system 1 includes a registration terminal 10, a conference server device 11, and a plurality of attendance terminals 13, which are interconnected by a network N1, such as LAN (local area network).

The registration terminal 10 is configured to register conference information and conference materials in the conference server device 11. Moreover, the registration terminal 10 is configured to register groups in the conference server device 11.

For example, an administrator of the teleconference system 1 may operate the registration terminal 10 to register a group in the conference server device 11, which will be described later. Moreover, an organizer and a presenter of a teleconference may operate the registration terminal 10 to associate conference information and conference materials with a group and register the association information in the conference server device 11, which will be described later. Hence, the registration terminal 10 is a device which is operated by the administrator of the teleconference system 1 and the organizer and the presenter of the teleconference.

The registration terminal 10 may be any of a PC (personal computer), a tablet terminal, a smart phone, a mobile phone, a PDA (personal digital assistant), a conference dedicated terminal, etc. Alternatively, the registration terminal 10 may be an image forming apparatus, such as a printer and a multifunction peripheral, or a projection apparatus, such as a projector.

The conference server device 11 is configured to manage groups, conference information, and conference materials. In response to receiving a conference list request from an attendance terminal 13, the conference server device 11 supplies different conference lists for several groups to the attendance terminal 13, which will be described later.

Moreover, the conference server device 11 is configured to perform holding of a teleconference and participation control, and distribute a presenter's input operation in real time to the attendance terminals 13 under participation. The conference server device 11 may be implemented by a processor or processing circuitry executing a program or a service read from a memory. Alternatively, the conference server device 11 may be constructed in a form of a cloud service.

The attendance terminal 13 is configured to acquire conference lists, conference information and conference materials from the conference server device 11, and configured to participate in a teleconference. A presenter and participants of a teleconference may operate the attendance terminal 13 to participate in the teleconference. Hence, the attendance terminal 13 is a device which is operated by the presenter and the participants of the teleconference.

The attendance terminal 13 may be any of a PC, a tablet terminal, a smart phone, a mobile phone, a PDA, an electronic white board, a projector, a conference dedicated terminal, etc. Alternatively, the attendance terminal 13 may be an image forming apparatus, such as a printer or a multifunction peripheral. When participating in a teleconference, the attendance terminal 13 receives an input operation by a presenter of the teleconference from the conference server device 11 in real time and shares a display screen with other attendance terminals 13.

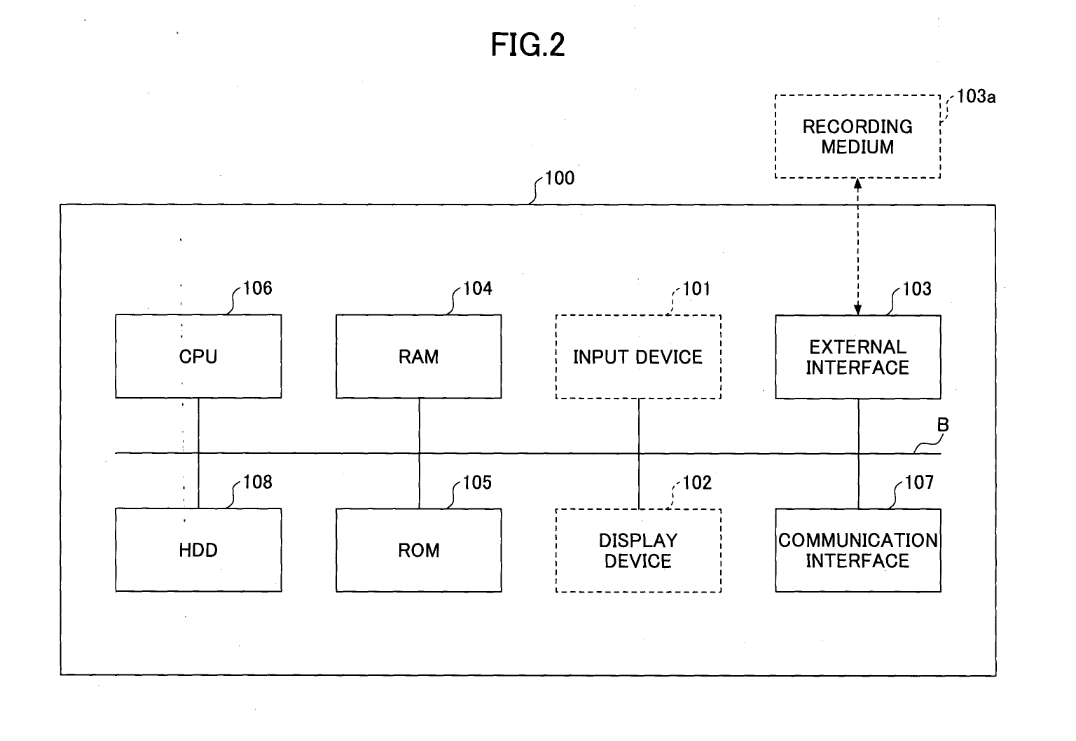

Each of the registration terminal 10, the conference server device 11, and the attendance terminal 13 may be implemented by a computer 100 having a hardware configuration as shown in FIG. 2. FIG. 2 is a block diagram showing a hardware configuration of the computer 100 according to this embodiment. As shown in FIG. 2, the computer 100 includes an input device 101, a display device 102, an external interface 103, a RAM (random access memory) 104, a ROM (read-only memory) 105, a CPU (central processing unit) 106, a communication interface 107, and a HDD (hard disk drive) 108, which are interconnected by a bus B. Incidentally, the input device 101 and the display device 102 may be connected and used when required.

The input device 101 is implemented by a keyboard, a mouse, a touch panel, etc., and used to input an operation signal to the computer 100. The display device 102 is implemented by a display, etc., and displays a processing result by the computer 100.

The communication interface 107 is an interface used to connect the computer 100 to the network N1. Hence, the computer 100 is configured to perform data communication with another computer 100 by means of the communication interface 107.

The HDD 108 is an example of a nonvolatile storage unit which stores programs and data. The programs and data stored in the HDD 108 include an OS (operating system) as a basic software to control the overall computer 100, and application programs executed on the OS to provide various functions. Alternatively, the computer 100 may be equipped with a drive device using a flash memory as a recording medium, such as a solid state drive (SSD), instead of the HDD 108.

The external interface 103 is an interface used to connect the computer 100 with an external device. The external device with which the computer 100 is connected may include a recording medium 103a. Hence, the computer 100 is configured to read data from and write data to the recording medium 103a by means of the external interface 103. The recording medium 103a is implemented by any of a flexible disk, a CD, a DVD, an SD memory card, a USB memory, etc.

The ROM 105 is an example of a nonvolatile semiconductor memory (storage unit) which holds programs and data even when the power is turned off. The programs and data stored in the ROM 105 include a BIOS (basic input/output system) which is run upon a startup of the computer 100, OS settings, network settings, etc. The RAM 104 is an example of a volatile semiconductor memory which temporarily stores programs and data.

The CPU 106 is a processor or a processing circuitry which reads the programs and data from the storage unit, such as the ROM 105 or the HDD 108, onto the RAM 104 and performs processes to control and implement the functions of the overall computer 100. Alternatively, the computer 100 may be equipped with components other than these components in the hardware configuration shown in FIG. 2. For example, the computer 100 may be equipped with a camera, a microphone, and a speaker.

The registration terminal 10, the conference server device 11, and the attendance terminal 13 in the teleconference system 1 according to this embodiment may carry out various processes by executing programs on the computer 100 having the above-described hardware configuration.

The registration terminal 10, the conference server device 11, and the attendance terminal 13 in the teleconference system 1 according to this embodiment are implemented by the following functional configurations.

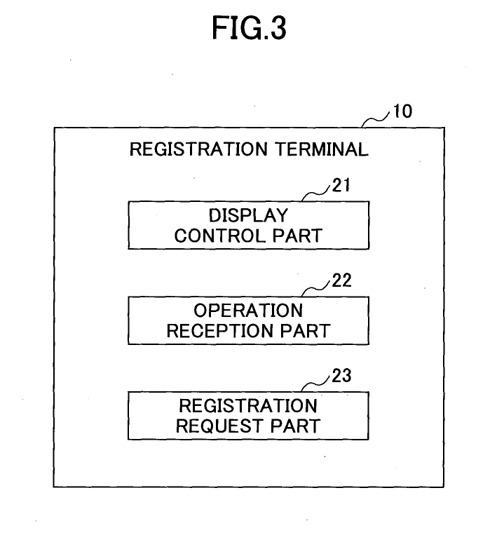

The registration terminal 10 may be implemented by a functional configuration as shown in FIG. 3. FIG. 3 is a block diagram showing a functional configuration of the registration terminal 10. In the registration terminal 10, a display control part 21, an operation reception part 22, and a registration request part 23 are implemented by the processor or processing circuitry of the registration terminal 10 executing the corresponding programs from the memory thereof.

The display control part 21 is configured to perform a process which displays a group registration screen, in response to an input operation performed by the administrator of the teleconference. Moreover, the display control part 21 is configured to perform a process which displays a conference registration screen, in response to an input operation performed by the organizer or the presenter of the teleconference.

The operation reception part 22 is configured to receive group information in response to an input operation performed by the administrator viewing the group registration screen. The operation reception part 22 is configured to receive conference information or conference materials in response to an input operation performed by the organizer or the presenter viewing the conference registration screen.

The registration request part 23 is configured to send a group registration request, including the group information having input to the group registration screen, to the conference server device 11, and register the group information in the conference server device 11. The registration request part 23 is configured to send a conference information registration request, including the conference information having input to the conference registration screen, to the conference server device 11, and register the conference information in the conference server device 11.

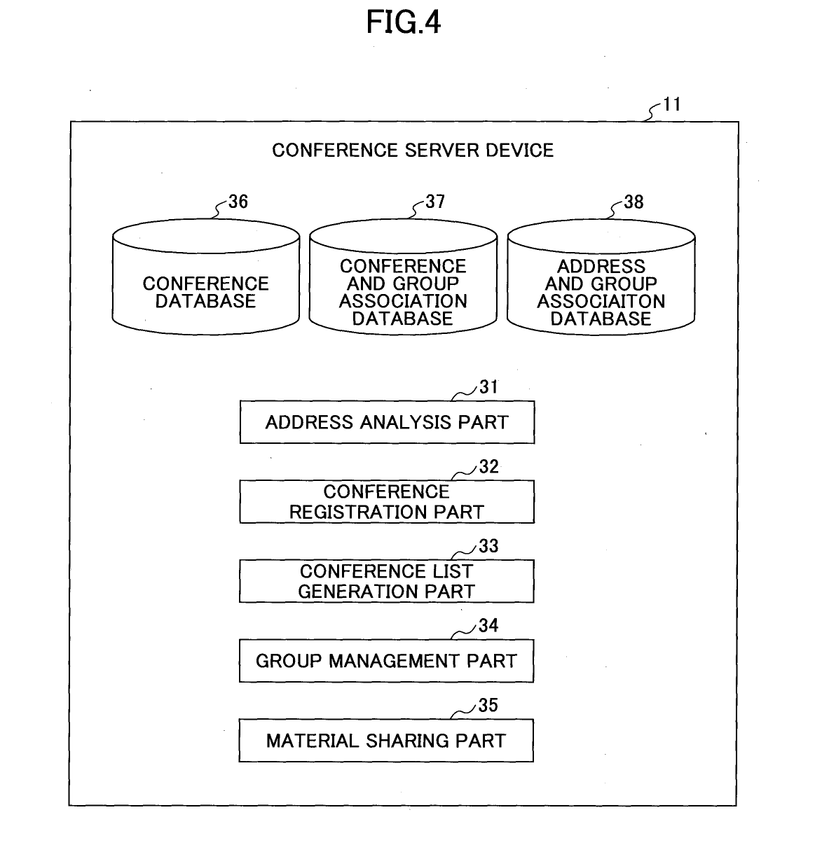

FIG. 4 is a block diagram showing a functional configuration of the conference server device 11 according to this embodiment. As shown in FIG. 4, the conference server device 11 includes an address analysis part 31, a conference registration part 32, a conference list generation part 33, a group management part 34, and a material sharing part 35, which are implemented by the processor or processing circuitry of the conference server device 11 executing the corresponding programs from the memory thereof. The conference server device 11 further includes a conference database 36, a conference and group association database 37, and an address and group association database 38.

The address analysis part 31 is configured to analyze one of a plurality of addresses assigned to the conference server device 11 when the one of the plurality of addresses is accessed by an external terminal device (i.e., the registration terminal 10 or the attendance terminal 13). The conference registration part 32 is configured to receive the conference information registration request from the registration terminal 10, and add information to the conference database 36 and the conference and group association database 37 in response to the received registration request.

The conference list generation part 33 is configured to generate, when a conference list request is received from the attendance terminal 13, a corresponding one of different conference lists for several groups, and supply the generated conference list to the attendance terminal 13. The group management part 34 is configured to receive a group registration request from the registration terminal 10, and add information to the address and group association database 38 according to the received registration request. The material sharing part 35 is configured to provide the teleconference system 1 with several functions, including a function of holding a teleconference, a function of performing participation control, and a function of distributing a presenter's input operation in real time to the attendance terminals 13 under participation.

The conference database 36 stores conference-related information including the conference information, the conference materials, etc. The conference and group association database 37 stores association information which associates a conference identifier (ID) and a group identifier (ID). The address and group association database 38 stores group information which associates an address and a group identifier (ID). Incidentally, the conference materials may be stored in a file server or the like other than the conference server device 11 by storing a storage location of the conference materials included in the conference information.

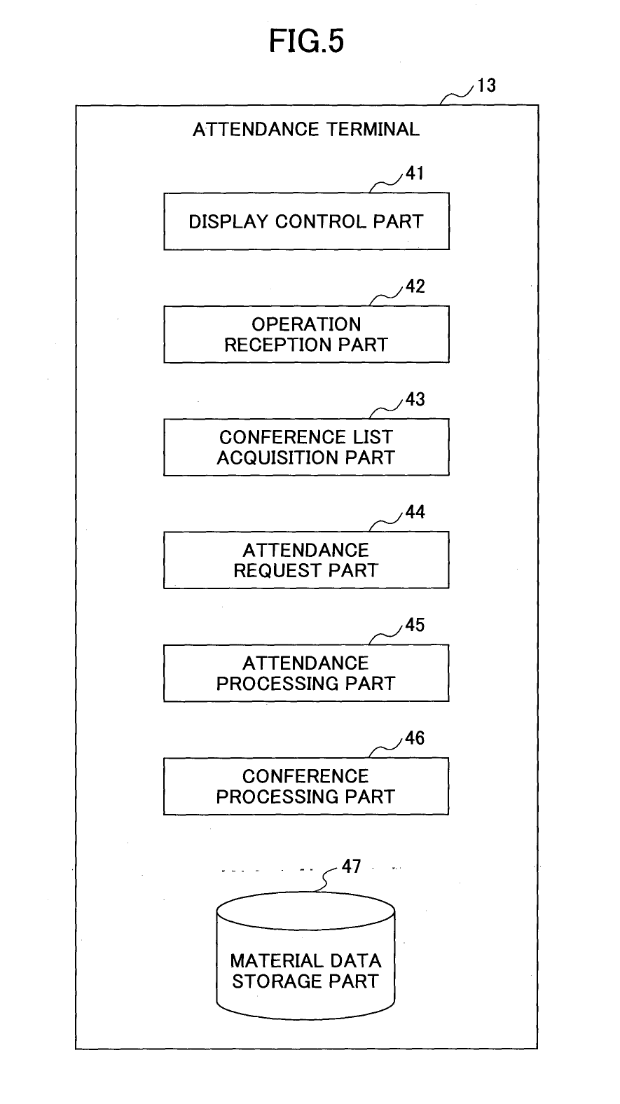

The attendance terminal 13 may be implemented by a functional configuration as shown in FIG. 5. FIG. 5 is a block diagram showing a functional configuration of the attendance terminal 13. In the attendance terminal 13, a display control part 41, an operation reception part 42, a conference list acquisition part 43, an attendance request part 44, an attendance processing part 45, and a conference processing part 46 are implemented by the processor or processing circuitry of the attendance terminal 13 executing the corresponding programs from the memory thereof. The programs executed by the processor or processing circuitry of the attendance terminal 13 may be the application programs installed in the attendance terminal 13. The attendance terminal 13 further includes a material data storage part 47.

The display control part 41 is configured to perform a process which displays a conference list screen or a conference screen, in response to an input operation by the presenter or the participant of the teleconference. The operation reception part 42 is configured to receive an input operation by the presenter or the participant viewing the conference list screen or the conference screen. The conference list acquisition part 43 is configured to send a conference list acquisition request to the conference server device 11. The conference list acquisition part 43 is configured to acquire from the conference server device 11 a list of teleconferences which will be held or participated in.

The attendance request part 44 is configured to send, to the conference server device 11, an attendance request related to a teleconference selected from the conference list, in response to an input operation by the presenter or the participant of the teleconference. The attendance processing part 45 is configured to receive the conference-related information including the conference information, the conference materials, etc., from the conference server device 11. The conference processing part 46 is configured to update the conference screen based on the presenter's input operation distributed by the conference server device 11, and share a display screen between the participating terminals of the teleconference system. The material data storage part 47 stores the conference-related information, including the conference information, the conference materials, etc., received from the conference server device 11.

Next, various processes performed by the teleconference system 1 according to this embodiment will be explained.

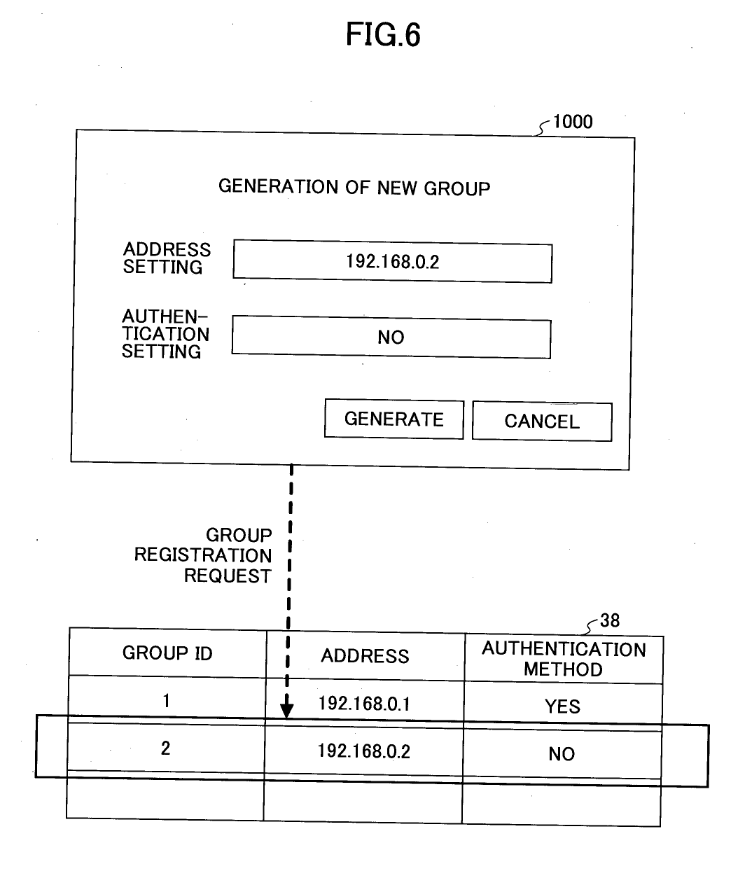

FIG. 6 is a diagram for explaining an example of a group registration process performed by the teleconference system 1. First, the administrator of the teleconference needs to register group information in the conference server device 11. When registering the group information, the administrator of the teleconference operates the registration terminal 10 to access an address of the conference server device 11 for providing a group registration screen, and display a group registration screen 1000.

As shown in FIG. 6, the group registration screen 1000 includes an address setting field for setting an address of the conference server device 11, an authentication setting field for setting an authentication method, and a “generate” button for registering group information to generate a group.

The address of the conference server device 11 which is displayed in the address setting field of the group registration screen 1000 may be one of all addresses currently assigned to the conference server device 11. Namely, in the teleconference system 1 according to this embodiment, a corresponding number of groups for all the addresses currently assigned to the conference server device 11 may be generated.

After an address and the necessity of authentication method are set into the group registration screen 1000 and the “generate” button is pressed by the administrator of the teleconference, the registration terminal 10 transmits the address and the necessity of authentication method, set in the group registration screen 1000, to the conference server device 11 together with a group registration request.

After the group registration request is received from the registration terminal 10, the conference server device 11 adds the address and the necessity of authentication method set in the group registration screen 1000 to the address and group association database 38 and associates the address and the necessity of authentication method with a new group in the address and group association database 38. Specifically, in the example of FIG. 6, a new group in which the group ID is set to “2”, the address is set to “192.168.0.2” and the authentication method is set to “no” is generated in the address and group association database 38 by the conference server device 11 in response to receiving the group registration request.

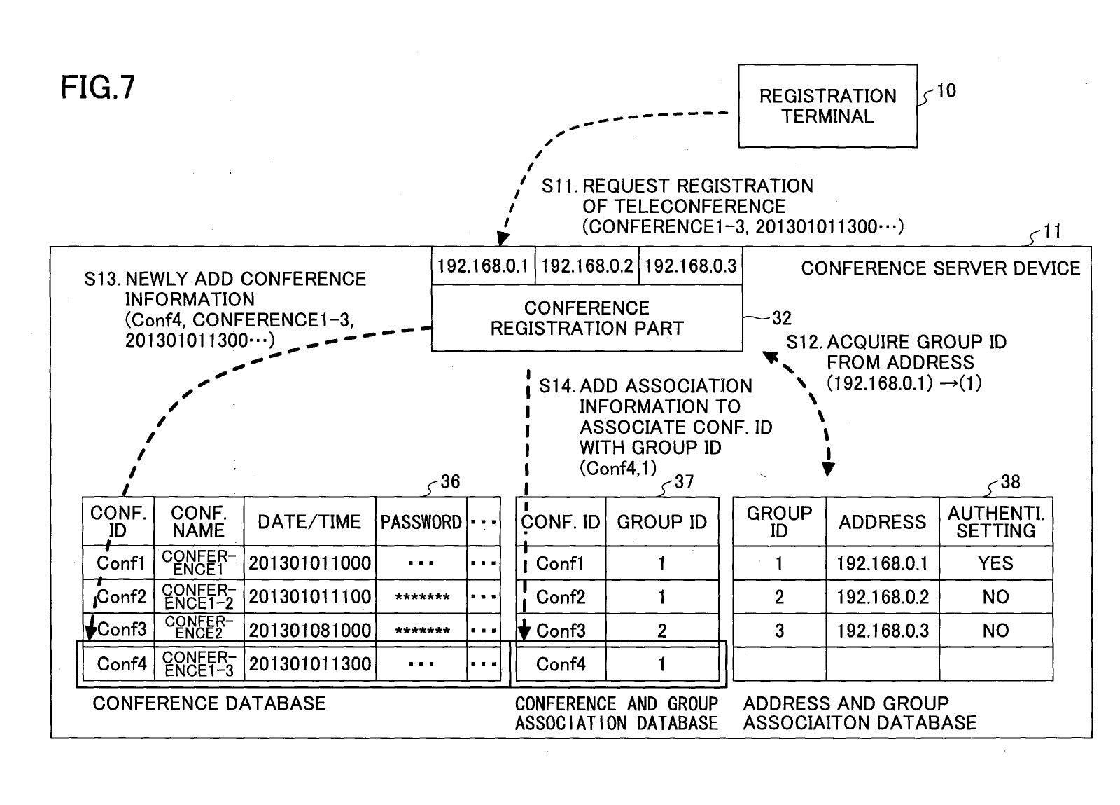

FIG. 7 is a diagram for explaining an example of a conference registration process performed by the teleconference system 1 according to this embodiment. It is necessary for the organizer or the presenter of a teleconference to register, prior to holding the teleconference, the conference-related information, including the conference information, the conference materials, etc., in the conference server device 11.

As shown in FIG. 7, in step S11, the organizer or the presenter of the teleconference operates the registration terminal 10 to access an address “192.168.0.1” of a conference registration screen which address is assigned to the conference server device 11. The display control part 21 in the registration terminal 10 displays the conference registration screen corresponding to the accessed address on the display device 102 of the registration terminal 10. The conference registration screen displayed on the display device 102 of the registration terminal 10 is a screen for allowing the organizer or the presenter of the teleconference to register the conference-related information including the conference information, the conference materials, etc. For example, the conference information may include a conference name of the teleconference, a date/time of the teleconference, a password, a storage location of the conference materials, etc. In step S11, the registration terminal 10 sends a conference information registration request, including the conference-related information having input to the conference registration screen, to the conference server device 11.

In response to receiving the conference information registration request from the registration terminal 10, the conference registration part 32 in the conference server device 11, in step S12, acquires a group ID “1” associated with the accessed address “192.168.0.1” from the address and group association database 38.

In step S13, the conference registration part 32 generates a unique conference ID “Conf4” and adds the conference ID “Conf4” to the conference database 36 together with the conference-related information which has input to the conference registration screen and includes the conference name “conference 1-3”, the date/time “201301011300”, etc.

In step S14, the conference registration part 32 adds association information to associate the group. ID acquired at step S12 with the conference ID of the conference-related information added to the conference database 36 at step S13 to the conference and group association database 37. For example, in the example of FIG. 7, the association information to associate the conference ID “Conf4” with the group ID “1” is added to the conference and group association database 37. According to the conference registration process shown in FIG. 7, the conference ID of the conference-related information having input to the conference registration screen is associated with the group ID, and the association information to associate the conference ID with the group ID may be registered in the conference server device 11.

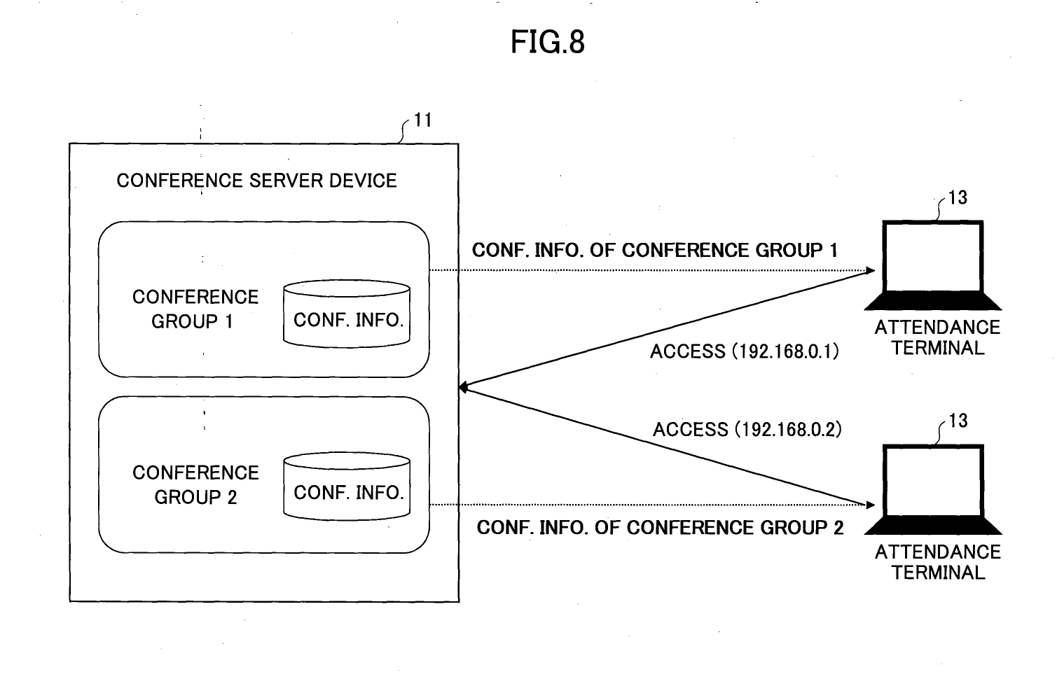

FIG. 8 is a diagram for explaining an example of a process which acquires the conference information for which grouping is carried out. It is assumed that an address “192.168.0.1” and an address “192.168.0.2” are assigned to the conference server device 11, and that, in the conference server device 11, a “conference group 1” is associated with the address “192.168.0.1” and registered, and a “conference group 2” is associated the address “192.168.0.2” and registered.

For example, if the attendance terminal 13 accesses the address “192.168.0.1” of the conference server device 11 and sends a conference list acquisition request to the conference server device 11, then the attendance terminal 13 may acquire a conference list which is generated based on the conference information associated with the “conference group 1.”

Moreover, if the attendance terminal 13 accesses the address “192.168.0.2” of the conference server device 11 and sends a conference list acquisition request to the conference server device 11, then the attendance terminal 13 may acquire a conference list which is generated based on the conference information associated with the “conference group 2.”

In this way, in the teleconference system 1 according to this embodiment, when it is desired to provide separate information items for several groups, the conference information may be grouped into the addresses (e.g., IP addresses) assigned to the conference server device 11. Incidentally, in the teleconference system 1 according to this embodiment, the single conference server device 11 may be used independently for each of the groups. Hence, it is possible to save the cost needed to install a plurality of conference server devices 11 and the time and effort needed to manage the plurality of conference server devices 11. Furthermore, it is not necessary for the teleconference system 1 according to this embodiment to manage a group with a user's account or the like, and the account management by the administrator of the teleconference system 1 and the login process by the presenter and the participants of the teleconference become unnecessary.

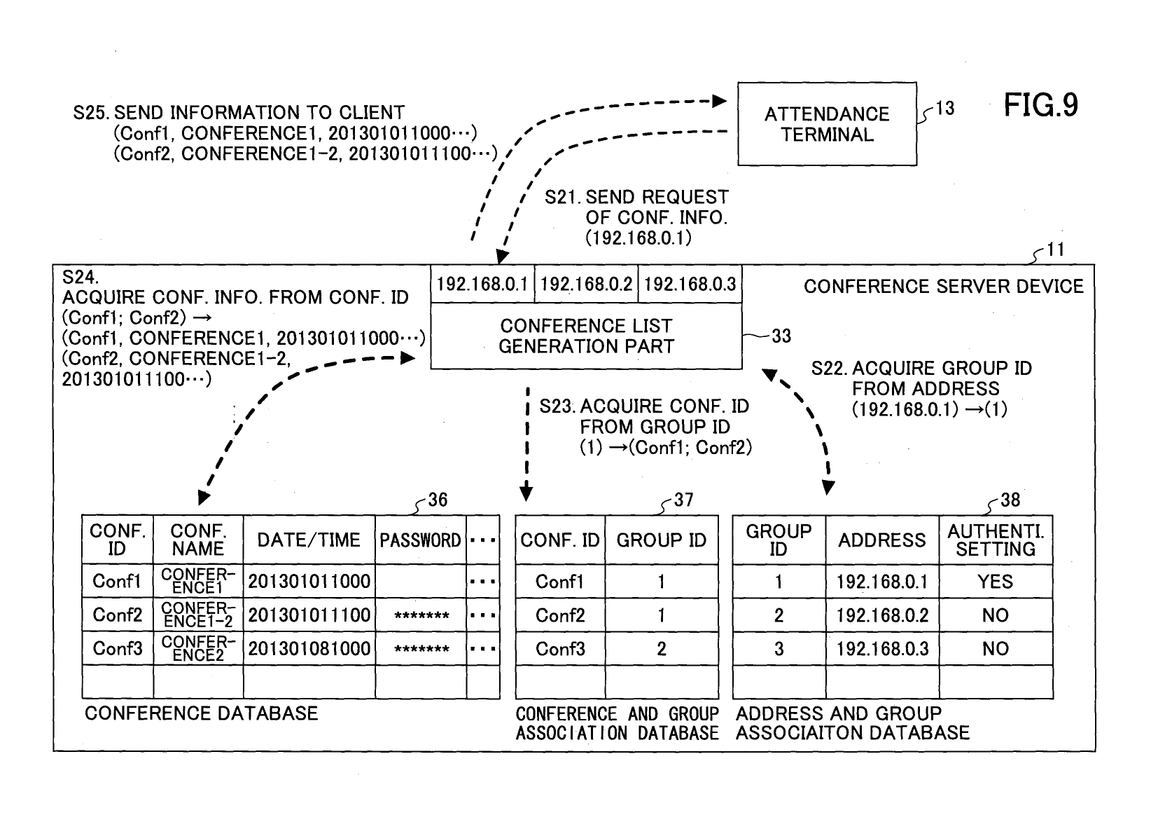

FIG. 9 is a diagram for explaining an example of a conference list acquisition process performed by the teleconference system 1 according to this embodiment.

As shown in FIG. 9, in step S21, the presenter or the participant of the teleconference operates the attendance terminal 13 to access an address “192.168.0.1” of a conference list screen which address is one of a plurality of addresses assigned to the conference server device 11.

The address analysis part 31 in the conference server device 11 analyzes the address “192.168.0.1” which is accessed by the attendance terminal 13. In step S22, the conference list generation part 33 in the conference server device 11 acquires a group ID “1” associated with the address “192.168.0.1” accessed by the attendance terminal 13 by making reference to the address and group association database 38. In step S23, the conference list generation part 33 acquires conference IDs “Conf1” and “Conf2” associated with the group ID “1” acquired at step S22, by making reference to the conference and group association database 37.

In step S24, the conference list generation part 33 acquires conference-related information which is associated with the conference ID “Conf1” acquired at step S23 and which includes a conference name “conference1”, a date/time “201301011000”, etc., by making reference to the conference database 36.

Moreover, in step S24, the conference list generation part 33 acquires conference-related information which is associated with the conference ID “Conf2” acquired at step S23 and which includes a conference name “conference1-2”, a date/time “201301011100”, etc., by making reference to the conference database 36.

The conference list generation part 33 generates a conference list which includes the conference information associated with the conference ID “Conf1” and the conference information associated with the conference ID “Conf2” based on the conference-related information acquired at step S24. In step S25, the conference list generation part 33 sends the generated conference list to the attendance terminal 13.

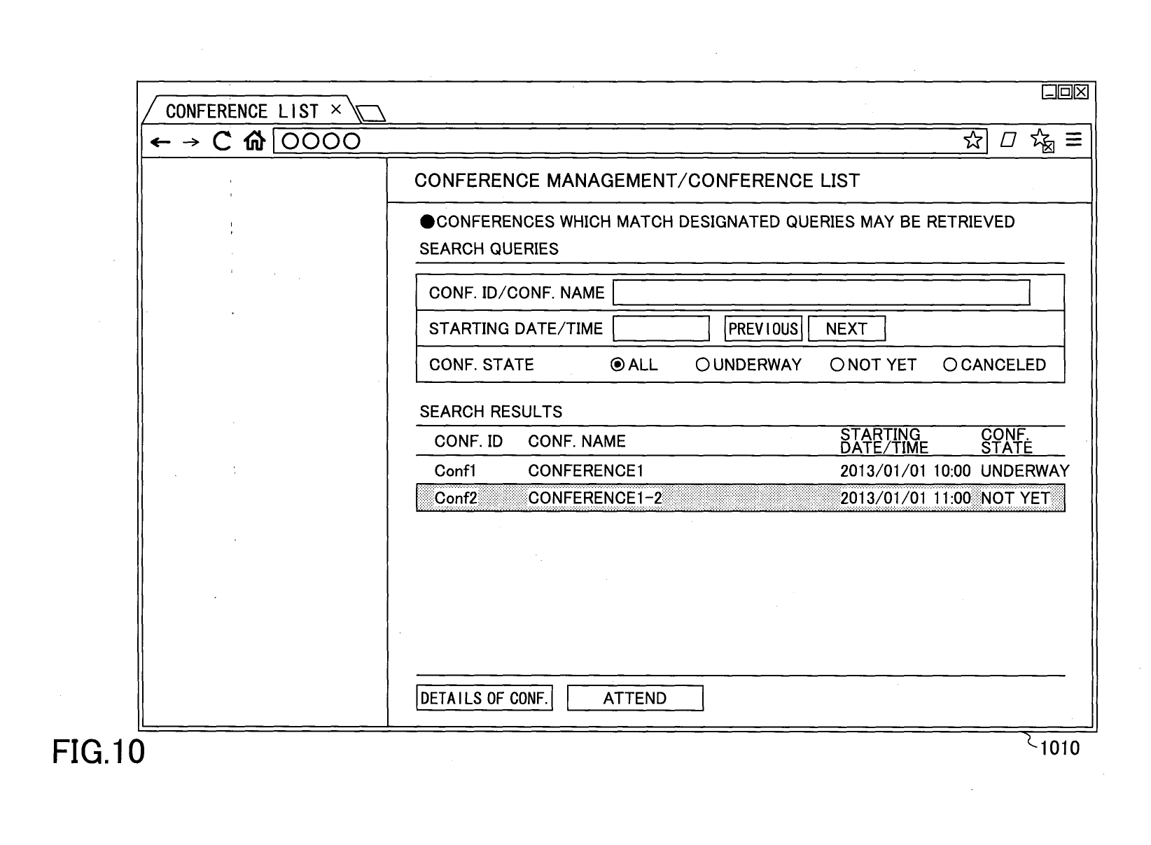

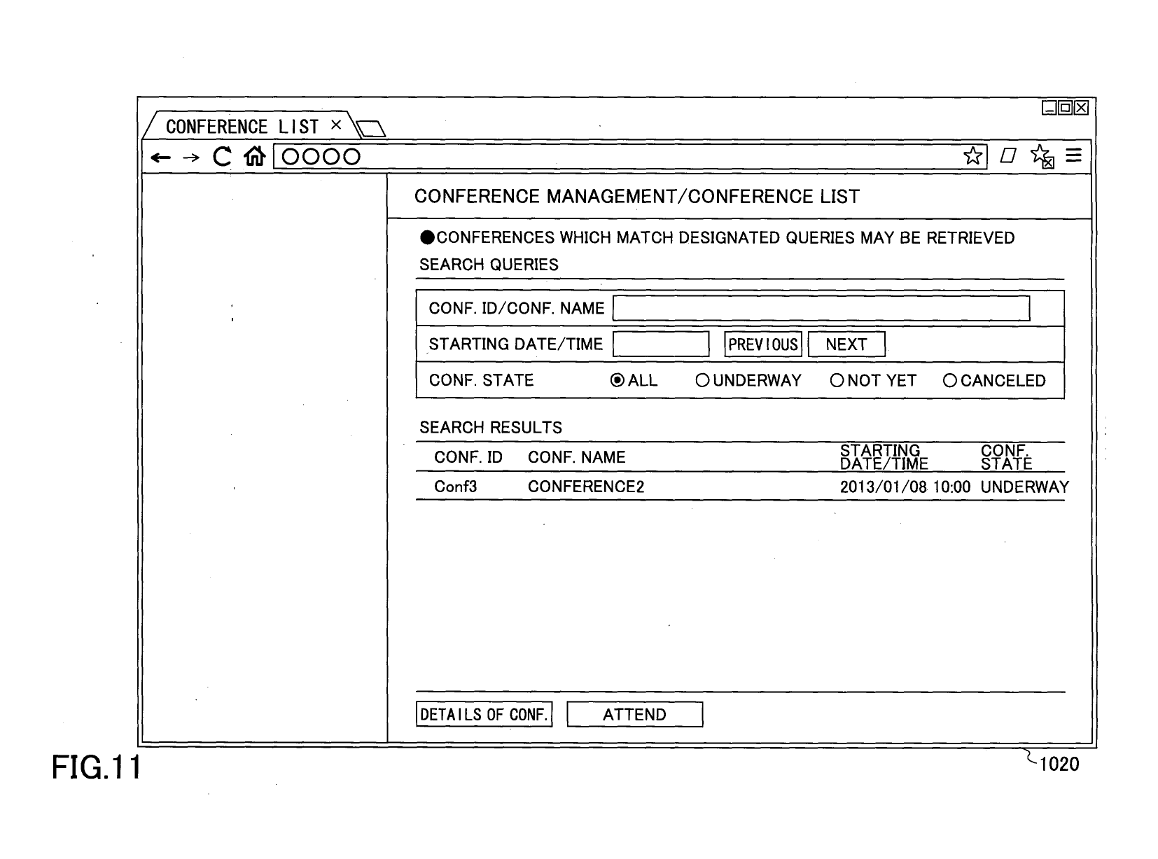

According to the conference list acquisition process shown in FIG. 9, the attendance terminal 13 is capable of easily acquiring the conference list of the groups in which the attendance terminal 13 participates from the conference server device 11. FIG. 10 and FIG. 11 show examples of a conference list screen which is acquired from the conference server device 11 and displayed on the attendance terminal 13.

FIG. 10 is a diagram showing an example of the conference list screen. FIG. 11 is a diagram showing another example of the conference list screen. Specifically, a conference list screen 1010 shown in FIG. 10 is an example when the attendance terminal 13 accesses the address “192.168.0.1” assigned to the conference server device 11. Moreover, a conference list screen 1020 shown in FIG. 11 is an example when the attendance terminal 13 accesses the address “192.168.0.2” assigned to the conference server device 11. Accordingly, the teleconference system 1 according to this embodiment is capable of easily performing a process which provides separate information items (the conference lists with which the attendance terminal 13 is provided from the conference server device 11 for every group.

As described in the foregoing, in the teleconference system 1 according to this embodiment, when it is desired to provide separate information items for several conference groups, plural addresses are assigned to the conference server device 11 and the addresses are associated with the conference groups so that the grouping of the teleconference system 1 may be performed according to the addresses. The attendance terminal 13 may acquire one of separate conference lists corresponding to the groups by accessing the corresponding one of the addresses assigned to the conference server device 11.

For example, in a case where two addresses A and B are assigned to the conference server device 11, a group A is associated with the address A and registered in the conference server device 11, and a group B is associated with the address B and registered in the conference server device 11. In this case, the attendance terminal 13 may acquire a conference list of the group A by accessing the address A assigned to the conference server device 11.

In the teleconference system 1 according to this embodiment, the assignment of plural addresses to the conference server device 11 is assumed. However, the DNS (domain name system) using the same port may also be used. Moreover, in the teleconference system 1 according to this embodiment, different processes may be performed for the addresses, or a common process may be performed for each of the addresses.

The information providing apparatus according to the present invention is not limited to the above-described embodiments and various variations and modifications may be made without departing from the scope of the present invention. For example, in the foregoing embodiment, the teleconference system 1 has been described as an example of the information service system. The present invention is also applicable to a system adapted to supply and display information on a seminar system, an educational system, etc. Moreover, the information providing apparatus according to the present invention is also applicable to groupware modules or web services.

The conference server device 11 in the foregoing embodiment is an example of the information providing apparatus as defined in the claims, the registration terminal 10 or the attendance terminal 13 in the foregoing embodiment is an example of a terminal device as defined in the claims, the address analysis part 31 in the foregoing embodiment is an example of an address analysis unit as defined in the claims, and the conference list generation part 33 in the foregoing embodiment is an example of an information providing unit as defined in the claims. Moreover, the group management part 34 in the foregoing embodiment is an example of a group registration unit as defined in the claims, and the conference registration part 32 in the foregoing embodiment is an example of an information registration unit as defined in the claims. Furthermore, any examples described herein are intended to aid in understanding the principles of the invention, and are to be construed as being without limitation to such specifically recited examples and conditions. As a result, the invention is not limited to the specific embodiments or examples described above, but by the claims and their equivalents.

Incidentally, the teleconference system 1 including the registration terminal 10, the conference server device 11, and the attendance terminals 13 is an example. It can be readily understood that the information providing apparatus according to the present invention may also be applied to various system configurations depending on the use or the purpose.

The present application is based on and claims the benefit of priority of Japanese Patent Application No. 2014-032498, filed on Feb. 24, 2014, the entire contents of which are hereby incorporated by reference.

1. An information providing apparatus that provides a terminal device with information, comprising:
a processing circuitry; and
a memory storing computer readable code that, when executed by the processing circuitry, causes the processing circuitry to act as
an address analysis unit configured to analyze one of a plurality of addresses assigned to the information providing apparatus when the one of the plurality of addresses is accessed by the terminal device; and
an information providing unit configured to acquire a group associated with the address analyzed by the address analysis unit based on group information in which a plurality of groups is associated with the plurality of addresses, and provide the terminal device with information associated with the acquired group.

2. The information providing apparatus according to claim 1, wherein the computer readable code when executed by the processing circuitry causes the processing circuitry to further act as a group registration unit configured to receive a group registration request from the terminal device, associate an address selected from among the plurality of addresses by the terminal device with a new group, and register the new group in the information providing apparatus.

3. The information providing apparatus according to claim 1, wherein the computer readable code when executed by the processing circuitry causes the processing circuitry to further act as an information registration unit configured to receive an information registration request from the terminal device and register information to be provided to the terminal device in the information providing apparatus by associating the information to be provided to the terminal device with a group associated with one of the plurality of addresses at which the information registration request is received from the terminal device.

4. The information providing apparatus according to claim 1, wherein the group information includes an address, a group identifier, and an authentication setting which are associated.

5. The information providing apparatus according to claim 1, wherein the information providing unit generates a list based on the information associated with the acquired group and provides the terminal device with the list.

6. The information providing apparatus according to claim 1, wherein the plurality of addresses is a plurality of IP addresses assigned to the information providing apparatus.

7. A non-transitory computer-readable recording medium storing a program representing computer readable code that, when executed by a computer, causes the computer to perform an information providing method comprising:
analyzing one of a plurality of addresses assigned to the information providing apparatus when the one of the plurality of addresses is accessed by the terminal device;
acquiring a group associated with the analyzed address based on group information in which a plurality of groups is associated with the plurality of addresses; and
providing the terminal device with information associated with the acquired group.

8. An information providing method performed by an information providing apparatus that provides a terminal device with information, the method comprising:
analyzing one of a plurality of addresses assigned to the information providing apparatus when the one of the plurality of addresses is accessed by the terminal device;
acquiring a group associated with the analyzed address based on group information in which a plurality of groups is associated with the plurality of addresses; and
providing the terminal device with information associated with the acquired group.
